(19) United States
(12) Patent Application Publication
(10) Pub. No.: US 2008/0301672 A1
(43) Pub. Date: Dec. 4, 2008

(54) Installation of a Software Product on a Device with Minimal User Interaction

(75) Inventors: Vivek R. Rao, Redmond, WA (US); Sorin M. Jianu, Seattle, WA (US); Erik A. Kay, Belmont, CA (US); Michael H. Tsao, San Mateo, CA (US); John G. Mevissen, Edmonds, WA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/755,685

(22) Filed: May 30, 2007

(51) Int. Cl. G06F 9/445

(52) U.S. Cl. 717/177; 717/176

(57) ABSTRACT

Described are systems and methods for installing software products on a computer. A software product is identified and authorized for installation on a computer. Parameters useful for installing the software product are identified and transmitted to a server. Installations instructions are received from the server, and the identified software product is automatically installed according to the received instructions.

### TECHNICAL FIELD

This description relates to code installation and configuration management.

### BACKGROUND

When a user desires to install a software application on a computer, the process typically involves a long series of prompts to which the user must respond in order to complete the installation process. Furthermore, if the user is a member of a larger enterprise, there may be issues of security and authorization that must be addressed with each software installation request. Such issues may require action by a systems administrator or other high level security agent. When more than one user has access to a computer, the software application may be installed such that some users have access to certain versions of the software application, other users have access to other versions of the software application, and still other users are restricted from accessing the software application. Any of the installed software applications, including those supporting separate versions, may require maintenance in the form of software updates in order to provide additional features, to fix bugs, to increase robustness, to block security holes, or to address other issues.

### SUMMARY

Users may want to install additional software products on their computers. Systems and methods can be implemented to perform software product installation requiring little or no interaction with the user.

In one general aspect, a software product is identified as available for installation on a computer. After authorization to install the product is received, parameters are identified for use in installing the software product and these parameters are transmitted to a server. Instructions for installing the software product are received from the server and the software product is automatically installed according to the received instructions.

Implementations can include one or more of the following features. The authorization request is presented on a web browser, and after receiving authorization, the installation proceeds with no further user action. A service module identifies and collects the identified parameters, which can be based on parameters associated with a previous software installation. The installation instructions can specify the location of components, including downloadable components, required to complete the installation. The installation components can be located on the same server that sends the instructions or on a different server.

The details of one or more implementations are set forth in the accompanying drawings and the description below. Other features will be apparent from the description and drawings, and from the claims.

### DESCRIPTION OF DRAWINGS

FIG. 1 is a block diagram illustrating an example configuration of a shared automatic installation and update system for multiple software products.

FIG. 2 is an example signaling and flow diagram illustrating operations of a shared automatic installation and update system for multiple software products.

FIG. 3 is a flow diagram of an example process for maintaining multiple versions of a software application on a computer system.

FIG. 4 is a flow diagram of an example process for updating software applications on a computer system.

FIG. 5 is a flow diagram illustrating an example process for dynamic self-updating by a software application supported by an automatic installation and update system.

FIG. 6 is a flow diagram illustrating an example process for installing a software product supported by an automatic installation and update system on a computer system with minimal user interaction.

Like reference symbols in the various drawings indicate like elements.

### DETAILED DESCRIPTION

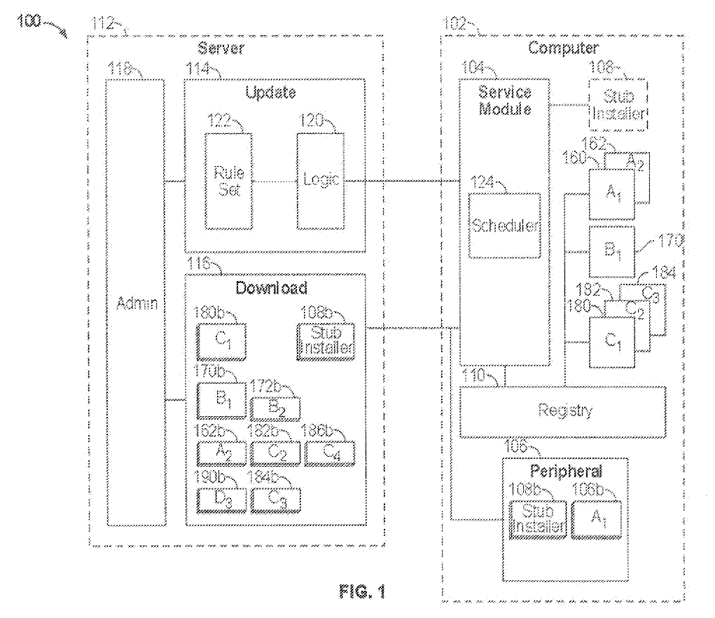

Typical software applications are installed and updated on an individual basis. In other words, each software application has its own corresponding installer and update mechanism. A shared automatic installation and update system for multiple software products, however, can provide more efficient and beneficial results. FIG. 1 illustrates an example configuration for a shared automatic installation and update system 100 for multiple software products 160, 162, 170, 180, 182, 184, and 190.

Prior to or concurrent with the first installation of a software application supported by the automatic installation and update system 100 on a computer 102, a software maintenance service module 104 (“service module”) may be installed on the computer 102. In some implementations, the installation of the service module 104 is completely transparent to the user of the computer 102, and occurs in conjunction with the installation of the software application. Installation may be initiated, for example, when the user of the computer 102 visits a web page offering the software application for download, or when the user accesses a CD-ROM, DVD, or other storage peripheral containing the binary files necessary to complete an installation of the software application.

When the user starts the download process, such as by clicking a button on the web page or by accessing the storage peripheral, a stub installer 108 for the service module 104 may be invoked by accessing the binary files necessary to complete the installation of the service module 104 and by executing the stub installer 108. In some implementations, the stub installer binary files are less than 172 kilobytes in size and take less than one minute to download over a 28.8 kbps link at 10 wire bits per 8 data bits. The stub installer 108 may contain references providing at least enough information for the service module 104 to complete the installation of the requested software product. In some implementations, a full installer can be provided to facilitate installation of the requested software product when a network connection is unavailable. If multiple software products are requested, the stub installer 108 may queue the multiple requests to enable the service module 104 to complete the multiple software product installations. The stub installer 108 may terminate and may be deleted or otherwise effectively removed from the computer 102 after the service module 104 and the requested software products are installed.

For example, in some implementations, if a user of the computer 102 installs Software Application A 160 from a CD-ROM 106, and Software Application A 160 is the first software product supported by the automatic installation and update system 100 installed on computer 102, then the binary files 108b can be accessed and the stub installer 108 can be invoked to install the service module 104 on the computer 102. The service module 104 may be installed without requiring any user action beyond that required to install Software Application A 160. The service module 104 then completes the download of Software Application A 160 by accessing the binary files 160b from the CD-ROM 106. The stub installer 108 can then terminate after the requested installation of Software Application A 160 is complete. In other implementations, instead of installing from a CD-ROM 106, the Software Application A 160, the stub installer 108, and/or the binary files 108b can be retrieved across a network connection (e.g., an Internet connection) from a download server 116.

After the service module 104 is installed on the user computer 102, subsequent requests to install one or more software products supported by the automatic installation and update system 100 may also invoke the stub installer 108 (or a different instance of the stub installer 108 that accompanies the one or more software products). In this case, the stub installer 108 may upgrade the service module 104 if a newer version is available, launch the service module 104 if the service module 104 is installed but not running, and terminate. If the stub installer 108 recognizes that the service module 104 is already installed, the stub installer 108 may initiate an uninstall process on itself.

In some implementations, the service module 104 includes a Microsoft WINDOWS™ (“WINDOWS™”) system service and the stub installer 108 is based on a traditional WINDOWS™ installer. In other implementations, the service module 104 and the stub installer 108 include features of other operating systems. The service module 104 may perform multiple installations and/or updates in parallel, multiple sequential installations and/or updates, and may resume or restart partially completed installations and/or updates.

In some implementations, a service module 104 installed and running on a computer 102 can consist of three major parts: (1) a runtime component which may handle the core update and install services; (2) a web browser control (e.g., ActiveX for Internet Explorer) which may allow web pages and applications supported by the automatic installation and update system 100 to send requests to the service module 104; and (3) a graphical user interface layer which may provide progress and feedback to the user during installation, updates, or any other services provided by the service module 104.

In some implementations, the service module 104 runtime functionality may be divided between a WINDOWS™ system service and worker processes. In some implementations, if the user has administrator privileges, the service module 104 is fully installed on the computer 102, the system service runs perpetually as a system entity, and the system service spawns worker processes to handle installations, updates, and other services provided by the service module 104. In this case, the spawned worker processes may also run as system entities when installing or updating software products according to a system profile, but may run as user entities when installing or updating software products according to a user profile. If the user lacks administrator privileges, the service module 104 may be installed as a user entity rather than a system entity, and may rely solely on worker processes that terminate when the user's session is terminated. In some implementations, if an instance of the service module 104 is installed as a user entity, and another instance of the service module 104 is subsequently installed as a system entity, the user instance will terminate while the more privileged system instance will survive.

In addition to installations according to a system profile, in which the software product is installed for general use by all users of the computer 102, and installations according to a user profile, in which the software product is installed for use by a particular user of the computer 102, software products may be installed according to a function profile, a role profile, or any other profile under which users can log onto the computer 102. For example, a software product may be installed for use by only those users who fulfill a particular role, such as developer of the software product or tester of the software product. In a second example, a software product may be installed for use by only those users who require a particular functionality in the software, such as those users who require that the software product provide French language output, or those users who require that the software product produce debug messages. Other types of profiles may also be available, and individual users may, for example, have access to or be allocated multiple different profiles.

As one example, a first version of Software Application C 180 may be installed according to a system profile, wherein any authorized user of the computer 102 can access the first version of Software Application C 180. A second version of Software Application C 182 may be installed according to a user profile for User X, wherein only User X can access the second version of Software Application C 182. A third version of Software Application C 184 may be installed according to a role profile for users designated as Developers. In this case, if User X is also designated as a Developer, then User X may be permitted to access all three versions of the Software Application C 180, 182, 184 installed on the computer 102. If User Y is also designated as a Developer, then User Y may be permitted to access both the first version of Software Application C 180 and the third version of Software Application C 184, but User Y may not be permitted to access the second version of Software Application C 182. If User Y is not designated as a developer, then User Y may be permitted to access only the first version of Software Application C 180.

After the service module 104 is installed on the computer 102, it may be invoked, for example, automatically. For system installations, the service module 104 may be invoked at power up, and a failover procedure may restart the service module 104 in case of a computer failure. For user installations, the service module 104 may be invoked as a worker process at user login. Although the service module 104 is described in the context of system installations and user installations, the same service module 104 (i.e., the same piece of code stored on the computer 102) may be invoked regardless of the type of active profile.

In some implementations, the service module 104 can provide for the simplified installation of applications supported by the automatic installation and update system 100. For example, the user may visit a web site providing access to a server 112 where at least one application supported by the automatic installation and update system 100 is available for download and installation. When the user selects an application for download and installation, such as by clicking a button on the web site, the service module 104 may identify and transmit to the server 112 any required installation parameters to facilitate the installation. The server 112 may then transmit installation instructions to the service module 104, allowing the download and installation to proceed with no further action required by the user (effectively providing for a “one-click” installation process). The installation instructions may include instructions to retrieve executable installation components from a particular server location. In some cases, the server location may be on the same server 112 that transmitted the instructions. In other cases, the server location may be on a different server remote from server 112.

The parameters transmitted by the service module 104 to the server 112 can provide information regarding security settings, privileges, user preferences, computing environment, or any other information relevant to the installation of the software application. In some cases, this information is provided to the service module 104 in conjunction with a prior installation of a software application on the computer 102. This information may be associated with a profile associated with the user, with a system profile, or with another profile that is either an active profile (e.g., a user is currently logged under the profile) or on behalf of which the service module 104 is otherwise authorized to perform updates.

In some implementations, the service module 104 can check whether any new versions of installed software applications are available and can facilitate the installation of the new versions for those profiles authorized to access the updates. The updates may occur with full, limited, or no user knowledge or input. For example, the service module 104 may communicate with a remote server to determine that a new version 162 is available for the installed Software Application A 160 and that updating to the new version 162 requires no additional authorization. In that case, the service module 104 may perform the update in the background or when the system is idle without notifying the user that the update is occurring, or may provide a status bar or some other indication that the update is occurring. In some cases, the service module 104 may prompt the user at least once for permission to perform the update.

Before an installed software application can receive updates, it may be necessary for the application to register with the service module 104. In some implementations, the application registration mechanism is based on WINDOWS™ registry. When a software application supported by the automatic installation and update system 100 is installed on a computer 102, the application may register with the service module 104 by creating and storing a key in the registry 110 on the computer 102. In some implementations, the key contains the installed software application's version number. For per-machine installations, the application may store the key in a location designated for system information, while for per-user installations, the application may store the key in a location designated for the specific user. The service module 104 may also register itself as an installed software product in order to check for the availability of new versions, security patches or other fixes, or other updates to the service module 104.

In some implementations, after one or more software applications have been installed on the computer 102 and have registered with the service module 104, the service module 104 will occasionally (e.g., periodically) check for updates and update the software applications when updates become available in accordance with known profiles. For example, a system instance of the service module 104 may occasionally update all applications installed according to a system profile, but may only update applications installed according to a user profile when the user is logged in. In another example, a user instance of the service module 104 may occasionally update applications installed specifically for that user, or may update applications installed for function profiles or role profiles associated with that user. Alternatively, in some implementations, it may be possible for the service module 104 to update multiple different applications or versions of applications that span across different system and/or user profiles.

Checks for updates by the service module 104 may be event-driven, such as when a user visits a particular web site. Checks for updates by the service module 104 may be periodic, for example, hourly or daily. To facilitate periodic updates as well as other periodic tasks associated with the service module 104, a scheduler 124 may be provided within the service module 104. In some implementations, the scheduler 124 runs inside the system service for a system instance of the service module 104, and the scheduler 124 runs inside the worker process for a user instance of the service module 104. The scheduler 124 may be provided as part of the operating system of the computer (e.g., the WINDOWS™ scheduler).

In some implementations, the service module 104 determines when updates are available for installed software applications 160, 162, 170, 180, 182, and 184 by communicating with a server 112 associated with the automatic installation and update system 100. The server 112 may be configured with two components: an update server component 114 and a download server component 116. When the update server 114 receives an update request from the service module 104, the update server 114 may respond with instructions pertaining to whether and how to update the set of installed software applications 160, 162, 170, 180, 182, and 184 on the client computer 102. The download server 116 may be primarily for hosting binary files associated with update requests. In some implementations, the server 112 can be a Java-based servlet engine and the update server 114 can receive requests and can reply with data in a response. The server 112 may receive information from the service module 104, such as software product identification and version number, embedded in a Uniform Resource Locator (URL) as query parameters, and return a response to be parsed by the service module 104.

For example, the service module 104 may send an update request to the server 112 identifying Software Application A 160, Software Application B 170, a first version of Software Application C 180, and a second version of Software Application C 182 as currently installed on the computer 102. In some implementations, a single update request identifies all installed software applications supported by the automatic installation and update system 100. In some implementations, a separate request identifies each software application supported by the automatic installation and update system 100. In addition to identifying which software applications are installed and which versions of those applications are installed, service module 104 may identify a particular profile for each software installation reported. For example, the service module 104 may associate Software Application A 160 with a system profile allowing access to all users of the computer 102, may associate Software Application B 170 with a User X profile, may associate first version of Software Application C 180 with a system installation allowing access to all users, and may associate second version of Software Application C 182 with a Developer profile. In some implementations, the update request may identify only software applications associated with a subset of the software applications and/or versions based, for example, on which profile or profiles are currently active. The request may identify a particular profile or simply identify specific parameters associated with the particular profile. In some implementations, the specific parameters included in the update request may be determined in accordance with information provided by the server 112.

The server 112 may then employ logic 120 and rule set 122 to determine whether updates exist for the installed software applications 160, 170, 180, and 182, and if so, whether the updates should be provided according to the identified user profiles and/or parameters. For example, the server 112 may determine that an update 162 exists for Software Application A 160 and that the update 162 is approved for all users. The server 112 may then communicate this information to the service module 104 along with instructions to update Software Application A and the location of the update files 162b. In some cases, such as if the update 162 is not approved for all users, the server 112 may instruct the service module 104 to retain the current version of Software Application A 160 for use by some users while installing the updated version 162 for use by those users operating under a particular profile. In another example, the server 112 may determine that an update 172 exists for Software Application B 170, but that the update is not available for User X. In that case, the server 112 may inform the service module 104 that no updates are available for Software Application B 170. In another example, the server 112 may determine that updates 184 and 186 exist for Software Application C, but that neither update is approved for all users or for Developers. In that case, the server 112 may inform the service module 104 that no updates are available for either first version Software Application C 180 or second version Software Application C 182. However, the server may inform the service module 104 that a third version of Software Application C 184 should be installed for users operating in a particular computing environment, i.e., a particular environmental profile.

The server 112 may have an administrative function 118 that supports creating and editing the configuration data, which may include the rule set 122 and/or the parameters that the server 112 instructs the service module 104 to collect, for the automatic installation and update system 100. In some implementations, this administrative function 118 is performed by a corporate servlet engine employing access control to create or edit entries. A web application may be responsible for simple error checking, such as verifying that a download URL is valid, and for providing an auditable change log.

Update request messages sent from the service module 104 may be in the form of a secure Hypertext Transfer Protocol (HTTPS) POST. The POST body can contain an Extensible Markup Language (XML) document with one or more request elements (e.g., for one or more applications, versions of applications, profiles, etc.). The server 112 response can be in the form of a Hypertext Transfer Protocol (HTTP) status and message body. The body can be an XML document with a response element corresponding to each of the client request elements. Each request can include an identification attribute corresponding to a particular installed software application that may be returned in the attributes of the corresponding response. Identification attributes, which may be echoed back by the server 112, may be limited to numeric characters only.

Client request elements may contain fields that identify attributes of the installed application specified in the request. Attributes of the client computer 102, of the system environment (e.g., other installed software applications, available peripherals, and the like), or of the service module 104 itself may also be passed to the server 112 in fields of the request. Such attributes may be associated with the system profile, with a user profile, with a function profile, and/or with any other profile and may include the version of the installed application. In some implementations, the version numbers assigned to software applications supported by the automatic installation and update system 100 are assigned according to the scheme of n1.n2.n3.n4, where n1 is the major revision number, n2 is the minor revision number, n3 is the build number, and n4 is the patch number. Multiple versions of a software application may be available for download to different classes of users according to their profiles. For example, version 1.1.54.0 may represent the latest public release of the software application, available to a general class of users; version 2.0.72.0 may represent the initial public pre-release of the 2.0 version of the software application, available to a class of trusted testers; version 2.0.73.0 may represent a test release, available to class of internal users; and version 2.0.76.0 may represent the latest development build, available to a class of developers.

A positive response to a service module 104 update request may be indicated by a status of “ok.” Such a response may indicate that an updated version of the identified installed software application is available for the specified user profile, and the response may identify a location where the requested update is maintained, whether administrator privileges are required for the update, instructions for obtaining and performing the update, and size and hash data. The size and hash data provide security assurance that the update is authentic. The size may be a decimal number of bytes, and the hash data may be a series of hexadecimal digits.

A negative response to a service module 104 update request may be indicated by a status of “no_update.” Such a response may indicate that no updates are available for the specified installed software application or for the particular profile for which the update is requested. A request to update an application that that is not supported by the server 112 may be indicated by a status of “unknown_application.”

The server 112 may determine whether specified installed software applications should be updated, and if so with which particular version, by examining the attributes contained in the request from the service module 104, by examining tokens or other external variables, by a combination of the two methods, or by any other method of identifying the software application and the profile for which the software application is installed. Examples of external variables include, but are not limited to, corporate credentials or other authorization tokens, Internet Protocol (IP) address, and shared secrets such as registry keys, embedded application tokens, etc. For example, a secret registry key plus an IP address may limit access to a software revision intended solely for developers, while an embedded application token may provide access to a software revision in beta release for testing.

Using the attributes contained in the request, the server 112 may inspect one or more attributes to determine which updates to provide for a particular application and/or version of an application. Another method the server 112 may employ is to compare the version of an installed application with the latest version available for each class of users. For example, if the comparison shows that a currently installed version is a version only available to a class of developers, then the server 112 may provide the most recent version of the software application available to the class of developers for installation by the service module 104.

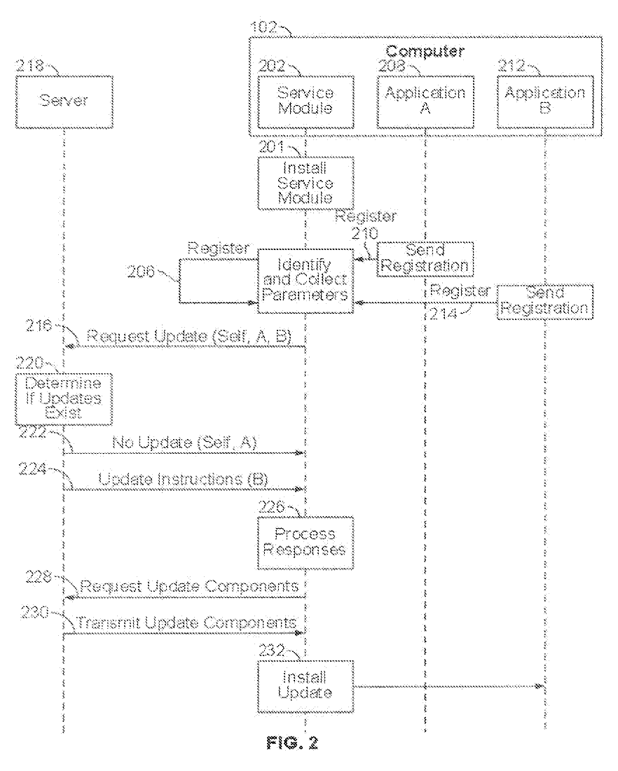

FIG. 2 provides a signaling and flow diagram illustrating an example operation of a shared automatic installation and update system 200 for multiple software products installed on a computer 102. In FIG. 2, after a service module 202 is installed on the computer 102 at 201, the service module 202 registers 206 with itself as a software application supported by the shared automatic installation and update system 200. Application A 208 then registers 210 with the service module 202 as a software application supported by the shared automatic installation and update system 200. Application B 212 then registers 214 with the service module 202 as a software application supported by the shared automatic installation and update system 200. Within process 204, the service module 202 may identify and collect information regarding itself 202 and Applications A 208 and B 212, including the version or versions of the software applications installed, information regarding preferences associated with users of the software applications 202, 208, 212, information regarding the system environment (e.g., the operating system, other installed applications, system hardware, and the like), information regarding profiles associated with the system, the software applications, and/or the users of the system, and other information in order to formulate a request for updates. Process 204 may continually run in the background on the computer 102.

The service module 202 then sends a request for updates 216 to the server 218. In the example of FIG. 2, the service module 202 sends one request 216 requesting updates for all installed software applications registered with the shared automatic installation and update system 200, in this case, itself 216, Software Application A 208, and Software Application B 212. In some implementations, the service module 202 may send multiple requests instead of a single request. Upon receiving the request for updates 216, the server 218, within process 220, may determine whether updates exist for the requested software applications based on information supplied by the service module 202 in the request 216. The server 218 may also use rule sets and other information in addition to the supplied information to determine whether to instruct the service module 202 to update any of the installed software applications.

In the example of FIG. 2, the server 218 determines that no updates are available for the service module itself 202 and for Software Application A 208. The server 218 communicates this information to the service module 202 in response 222. Although, in the example shown, the server 218 sends one response 222 for both applications 202, 208 that require no update, in some implementations, the server 218 may send multiple responses, such as an individual response for each of the installed software applications that require no update. In the example of FIG. 2, the server 218 determines that an update is necessary for Software Application B 212, and sends update instructions 224 to the service module 202. Although depicted as separate responses, the responses 222 and 224 may be sent in a single message.

The update instructions may include an identification of a server location from which software components representing the update and/or for installing the update can be retrieved. In process 226, the service module processes the responses 222, 224 received from the server 218 to determine that no updates are available for itself 202 or for Application A 208 but that an update is available for Application B 212. Accordingly, the service module 202 automatically sends a request 228 to retrieve update components from server 218. In some implementations, however, the update components may be retrieved from a different server (e.g., in a different location) and/or some of the update components may have been previously stored on the computer 102. In some implementations in response to the request 228, the server 218 sends 230 the requested update and/or installation components to the service module 202. The service module 202 then proceeds with installing 232 the update of Software Application B 212 in accordance with the instructions provided in the response 224. In general, all of the operations performed by the service module 202 can be done automatically without requiring input from a user of the computer 102. In some implementations, however, the user may be prompted in a web browser to supply authorization to initiate the installation of a software application or an update to a software application.

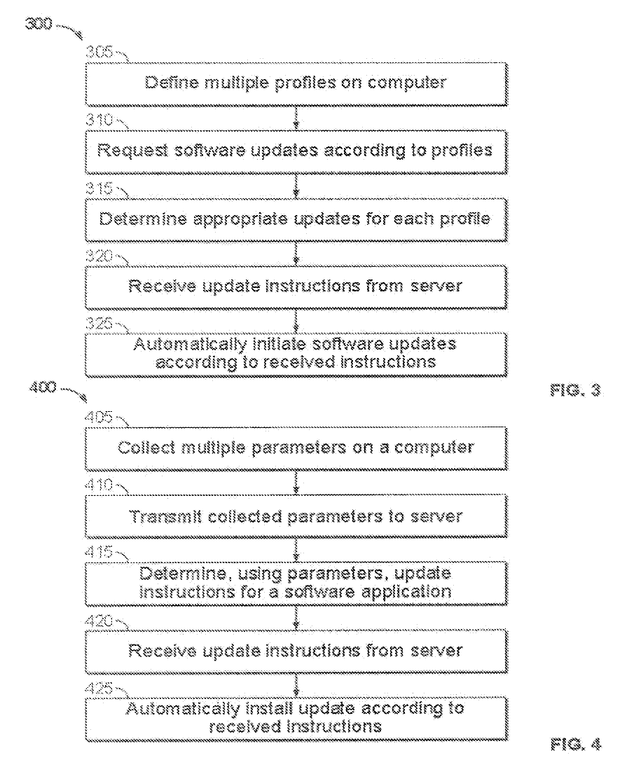

FIG. 3 is a flow diagram of an example process 300 for maintaining multiple versions of a software application on a computer system. The process 300 may be implemented by an update software module installed on a computer in combination with an update server. Multiple different profiles may be defined on the computer at 305. Each profile may have at least one attribute that differs from other profiles on the computer. For example, some attributes for a profile, such as the operating system or browser software, may be shared by many or all of the profiles on the computer, while other attributes may be unique to specific profiles. Each profile may be associated with multiple software applications or versions of software application. Thus, different profiles may be associated with different applications or different versions of the same application. In some cases, the different profiles may be associated with different users. Alternatively, a single user may have access to two or more different profiles (e.g., a system profile, a standard user profile, and a developer profile).

Separate requests for available software updates for a first profile and for a second profile are transmitted to the remote update server at 310. The requests may identify the different attributes or parameters associated with the first profile and the second profile for use in determining whether any updates are available and which updates are appropriate for each profile. The requests may be sent at the same time or at different times (e.g., when users of the different profiles log onto the computer concurrently or at different times). The requests may be sent automatically by the update module according to a predetermined time schedule or some other triggering event. For example, each request may be sent when the corresponding profile becomes active (e.g., a user logs onto the computer under the particular profile).

One or more appropriate updates for each profile are determined at 315. For example, the update server may analyze the different attributes for each profile, including an identification of one or more software applications associated with each profile, to determine whether any updates are available and which ones should be applied. Updates may be applied differently depending on the identified versions of software applications, language preferences, profile type, whether the profile has administrator privileges, etc. The update server may then generate instructions for updating the software applications associated with the different profiles. Again, these instructions may be generated at the same time or different times according to when the requests are received and may provide different instructions for different versions of the same software application installed on the same computer.

The instructions for updating the software applications or versions of applications associated with the different profiles are received from the server at 320. The instructions may be received by the update module on the computer, which may be adapted for carrying out the instructions, including retrieving any necessary update or installer components and executing the installation of the components with little or no user involvement or action required.

An update of the software applications associated with each of the profiles is automatically initiated in accordance with the received instructions at 325. For example, the update module on the computer may automatically install the necessary updates.

FIG. 4 is a flow diagram of an example process 400 for updating software applications on a computer system. The process 400 may be implemented by an update software module installed on a computer in combination with an update server. Multiple parameters on a computer are collected at 405. The parameters may include an identification of one or more software applications installed on the computer and/or associated or registered with the update module, an identification of the version of the software application stored on the computer, data relating to user preferences, computer environment data (e.g., operating system, available peripherals, available computer hardware, installed browser software, and the like), profile data (e.g., type of profile, attributes of the profile, and the like), and/or data relating to the update module itself. The parameters may be associated with a particular profile on the computer, such as a system profile, a user profile, a function profile, or a role profile. In some implementations, parameters may be collected for multiple different profiles either concurrently or during different active login sessions. The parameters may be collected using the update module, which may have been previously installed on the computer (e.g., during an earlier software installation). In some implementations, the parameters may identify one of multiple versions of a software application that are currently installed on the computer. The identified version may be associated with an active profile while the other versions may be associated with one or more inactive profiles or profiles for which updates have already recently been updated. The particular parameters collected may also be based on which profile or profiles are currently active. For example, one or more of the parameters may be associated with the profile on the computer rather than with the computer itself.

The collected parameters are transmitted from the computer to a remote server at 410. The parameters may be automatically transmitted by the update module according to a predetermined time schedule. The time schedule may have been previously assigned by a remote server and may call for periodic transmissions and/or transmissions that are triggered by some other event (e.g., opening a particular application). When parameters are collected for multiple different profiles, the different sets of parameters associated with each profile can be transmitted to the remote server in a single message or in different messages, which may be sent at different times. The parameters may be transmitted as part of a request for available software updates that is sent from the update module to the remote update server.

In response to the transmitted parameters and/or the request for available software updates, instructions for installing an update to a software application installed on the computer are determined based, at least in part, on the parameters at 415. The software application and the particular version of the application may be identified by one or more of the transmitted parameters. Moreover, different instructions may be provided for different sets of parameters. For example, the particular update to be installed on the computer may depend on the current version, the type of profile, the operating system, etc. The instructions may be dynamically generated based on the parameters according to rules stored at the remote update server. Thus, different updates may be provided to the same or different computers for different versions of a software application and/or for different sets of transmitted parameters. The instructions may also pertain to updates for more than one software application. For example, the update server may identify different updates for different software applications (based on the same or different sets of transmitted parameters) or even for different versions of the same software application (generally based on different sets of transmitted parameters). Once the instructions are generated or otherwise determined, they can be transmitted from the update server to the remote computer.

The instructions for installing an updated are received at 420. The instructions may direct the update module to retrieve one or more installer components from a remote download server, which may be at the same or a different location from the update server, and/or from a storage location on the computer, where one or more of the components may have been previously stored. In some implementations, instructions for updating one or more applications may be received in a single response message. In cases where different updates are identified for different software applications or different versions of the same software application, the instructions may be directed to a single computer or update module associated with the different software applications or different versions of the same application or may be directed to different computers having different sets of parameters.

The update is then automatically installed on the computer in accordance with the instructions at 425. For example, the instructions may direct the update module to retrieve installer and/or components from the remote download server and/or a local storage location and execute at least one executable component of the components. Thus, the instructions may identify one or more components and identify a location where the components can be found. The update module may also automatically install multiple updates for multiple software applications or versions of applications. In this manner, the update module can run silently (i.e., without disturbing the user), using a relative small number of resources because of the small size of the module, and also serve to maintain multiple different software applications by separating much of the intelligence for the updating from the update framework provided by the update module (and the remote update server and download server).

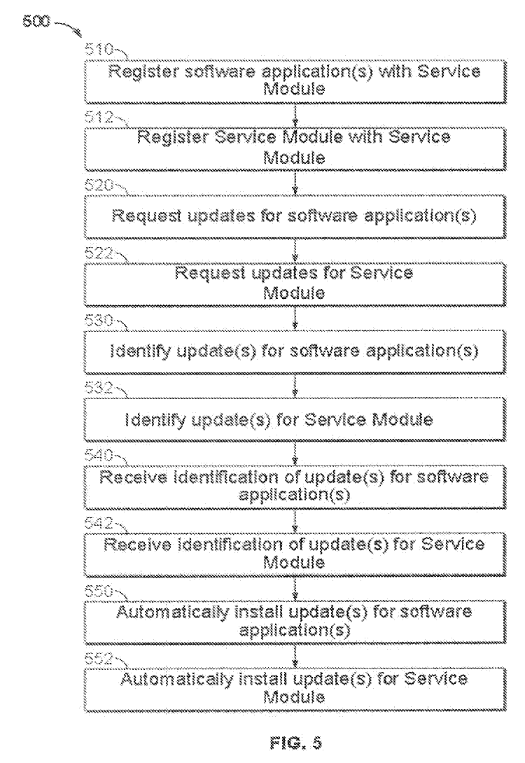

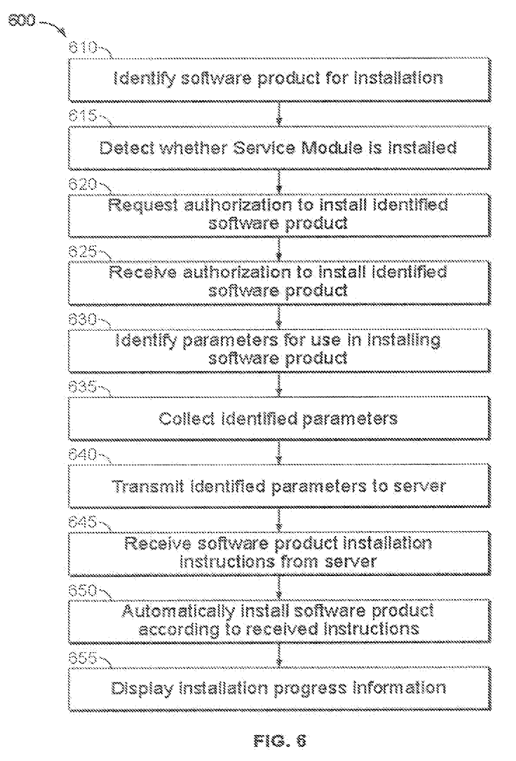

FIG. 5 illustrates an example process 500 for dynamic self-updating by a software application. One or more software applications supported by an automatic installation and update system may register with a service module installed on and executing in the application environment of a device (e.g., a computer) at 510. The service module may launch automatically, for example at computer startup or at profile activation, such as when a user logs in. Alternatively, the service module may launch in response to some triggering activity, such as the expiration of a scheduling timer. The software applications may actively register with the service module by sending registration messages or other communications. Alternatively, the software applications may be passively registered by the service module. For example, the registration may occur in conjunction with the initial installations of the software applications or with the initial installation of the service module. In some implementations, the service module may monitor for certain newly installed applications and/or search a computer for previously installed applications. The service module may also register with itself, identifying itself as a software application supported by the automatic installation and update system at 512.

The service module may then periodically or in response to some triggering activity check whether any updates are available for the supported software applications at 520 or for itself at 522. The service module may accomplish this by transmitting a request message to one or more update servers supported by the automatic installation and update system. The request may identify all installed supported software applications, a single installed supported software application, or some number of installed supported software applications, such as, for example, those available under an active profile or those available to a logged in user. Additionally, the request may provide a number of parameters describing the environment associated with each of the software applications, such as the computing environment, security requirements, profile data, or other information useful in determining whether updates are available for the installed software applications.

In response to receiving an update request from the service module, the update server may then determine that updates are available for at least one of the installed software applications at 530 and/or for the service module itself at 532. The server may make this determination based on information received in the request, by applying rules for determining whether updates are appropriate, or both. The service module may then receive from the server the identification of the available updates for the appropriate installed software application at 540 and/or for itself at 542. Identification of multiple available updates may be received in single response or in multiple responses. The server's identification response may include installation instructions for the update, for example, information on where to locate components, such as executable files, data files, etc., necessary to complete the update, and/or information specifying for which profiles the software application should be updated. The transmitted update instructions may have been generated by the server or generated by another entity and delivered to the server for transmission to the service module.

The service module may then proceed to install updates to the software applications at 550 and to itself at 552 in accordance with the information received from the server. The service module may retrieve one or more components from one or more servers, including the update server. In some implementations, the service module may perform the appropriate updates, including those to itself, in a manner that is transparent to the users of the software applications. In other implementations, the service module may prompt the user for permission to proceed, may provide a status bar or other indication of download progress, may request that the user restart the computer after the updates have finished, or otherwise engage the user in the process. When the service module proceeds transparently, it may perform the updates in the background or when the computer is idle.

FIG. 6 illustrates an example process 600 for installing on a computer, with minimal user interaction, a software product supported by an automatic installation and update system. A software product not currently installed on a user's computer may be identified for installation at 610. For example, a computer user may load an installation disk containing a new software application into the computer's CD-ROM drive, may click an installation button on a web site, or may attempt to perform a function not supported by any software product currently installed on the user's computer. In some implementations, a stub installer associated with the automatic installation and update system may be invoked to detect whether the service module is currently installed at 615. If the stub installer determines that the service module is not currently installed, the stub installer may install the service module and subsequently terminate. Alternatively, the stub installer may simply terminate after determining that the service module is currently installed, which may have occurred in association with a previous installation of a software product supported by an automatic installation and update system.

The service module may, in some implementations, request authorization from the user to proceed with the installation of the requested software product at 620, and receive the requested authorization at 625. In some implementations, the user's actions that resulted in identifying the software product may have also provided the necessary authorization, making an authorization request from the service module unnecessary. In some implementations, the service module may determine that installation is appropriate without user authorization, basing this determination on, for example, system security requirements, prior authorizations, profiles associated with the user, and/or profiles associated with the software product.

The service module may then identify one or more parameters on the computer for use in installing the identified software product at 630. These parameters may include information relating to security settings, privileges, computer environment attributes, profiles associated with the user, and/or profiles associated with the software product, and may include parameters associated with a previous installation of this or another software product. The service module may then collect the identified parameters at 635 and transmit the identified parameters at 640 to a server supported by the automatic installation and update system.

The service module may then receive installation instructions from the server at 645, for example, information on where to locate components, such as executable files, data files, etc., necessary to complete the installation, and/or information specifying for which profiles the software product should be installed. In some implementations, the installation instructions may direct the service module to retrieve components necessary to complete the installation from the server itself, from a different server, or from the user computer. The transmitted installation instructions may have been generated by the server or generated by another entity and delivered to the server for transmission to the service module.

The service module may then proceed to automatically install the software product at 650 in accordance with the information received from the server with no further user action required. In some implementations, the service module may provide a status bar or other indication of download progress at 655.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made. For example, although various operations are described in an particular or implied order, some operations may be performed concurrently or in a different order than described. In addition, although operations are described as being performed by particular devices or software modules, operations may be performed by components other than those described and illustrated. Accordingly, other implementations are within the scope of the following claims.

What is claimed is:

1. A method, comprising:
identifying a software product available for installation on a device;
receiving, from a user through a web browser on the device, an authorization to install the available software product;
identifying parameters on the device for use in installing the available software product in response to the received authorization;
transmitting the parameters to a server in communication with the device;
receiving installation instructions from the server in response to the transmitted parameters; and
automatically installing the software product in accordance with the instructions received from the server.

2. The method of claim 1, wherein, after receiving the authorization from the user, no further user action is required to install the software product.

3. The method of claim 1, wherein the parameters are identified based, at least in part, on parameters associated with a previous installation of another software product on the device.

4. The method of claim 1, further comprising:
collecting the parameters using a service module previously installed on the device.

5. The method of claim 4, wherein the service module is installed on the device in association with a previous installation of another software application.

6. The method of claim 5, further comprising:
detecting the service module installed on the device in response to receiving the authorization.

7. The method of claim 1, further comprising:
presenting, on the web browser, a request for the authorization to install the available software product in response to identifying the available software product, wherein the authorization is received in response to the request.

8. The method of claim 1, wherein the installation instructions comprise instructions to retrieve executable installation components adapted to install the available software product.

9. The method of claim 8, wherein the executable installation components comprise components stored on a remote server.

10. The method of claim 8, wherein the executable installation components comprise components stored on the device.

11. The method of claim 1, further comprising:
displaying information relating to a progress of the installation on a user interface of the device.

12. An article comprising:
a machine-readable medium storing a service module, wherein the service module includes software instructions for causing data processing apparatus to perform operations comprising:
receiving an indication of a request to install a particular software product;
automatically transmitting parameters to an installation server;
receiving instructions for installing the particular software product from the installation server in response to transmitting the parameters; and
automatically installing the particular software product in accordance with the received instructions.

13. The article of claim 12, wherein the parameters include at least one of security settings, privileges, and device environment attributes.

14. The article of claim 12, wherein the service module includes software instructions for further causing data processing apparatus to perform operations comprising collecting the parameters from a device that includes the machine-readable medium.

15. The article of claim 12, wherein the service module includes software instructions for further causing data processing apparatus to retrieve installation components in accordance with the instructions.

16. The article of claim 15, wherein the service module includes software instructions for further causing data processing apparatus to retrieve the installation components from a download server.

17. The article of claim 16, wherein the installation components include at least one executable component and the service module includes software instructions for further causing data processing apparatus to automatically execute the at least one executable component to install the particular software product.

18. The article of claim 12, wherein the request to install the particular software product is generated as a result of a user interaction with a browser on a device that includes the machine-readable medium.

19. A system for installing at least one software product, the system comprising:
a device;
a service module installed on the device, wherein the service module is adapted to:
receive a request to install a software product;
automatically transmit a plurality of parameters to a remote server in response to the received request to install the software product;
receive instructions for installing the software product; and
install the software product in accordance with the received instructions.

20. The system of claim 19, further comprising:
a stub installer adapted to detect whether the service module is installed on the device and, if the service module is not detected, to install the service module on the device.

21. The system of claim 20, wherein the stub installer is automatically removed after detecting that the service module is installed or after installing the service module if the service module is not detected.

22. The system of claim 19, wherein the service module is associated with a set of related applications, and the service module is adapted for use in installing any one of the applications in the set of related applications.

23. The system of claim 19, wherein the request to install the software product is initiated by a user interaction with web browser software on the device.

24. The system of claim 19, wherein the remote server operates to generate the instructions for installing the software product based on the plurality of parameters received from the service module.
